(19) United States
(12) Patent Application Publication
(10) Pub. No.: US 2009/0125944 A1
(43) Pub. Date: May 14, 2009

(54) NOVEL DIGITAL BROADCASTING VIEWING METHOD USING MY CHANNEL AND SYSTEM THEREOF

(75) Inventor: Hyeongjin Kim, Seoul (KR)

Correspondence Address: HOFFMANN & BARON, LLP, 6900 JERICHO TURNPIKE, SYOSSET, NY, 11791, US

(73) Assignee: ALTICAST CORP., Seoul (KR)

(21) Appl. No.: 11/994,673

(22) PCT Filed: Jul. 3, 2006
(86) PCT No.: PCT/KR06/02598

§ 371 Date: Jan. 4, 2008

(30) Foreign Application Priority Data
Jul. 5, 2005 (KR) 10-2005-0060086

(51) Int. Cl. H04N 5/445

(52) U.S. Cl. 725/46

(57) ABSTRACT

The present invention relates to a digital broadcasting viewing method. The method in accordance with the present invention is characterized in that a user can watch preference programs by selection of a particular virtual channel. The method of the present invention comprises the steps of (a) assigning at least one channel that is not allocated to broadcast regular programs by broadcasting stations as my channel, (b) bookmarking a program that a user wants to watch to the my channel based on a program guide information, and (c) in response to selection of the my channel by the user, displaying the bookmarked program on television screen of the user. Two or more channels may be assigned as my channel. Compared with the conventional method that allows only one channel to be reserved for the same time, the present invention makes it possible to reserve as many channels as the number of My Channels for the same time. By changing between the My Channels, the user can enjoy his/her preference programs without the complicated channel search. Since channel changing to the preference programs is carried out only by the user's My Channel selection, the interruption caused by automatic channel change in the conventional reservation system can be avoided.

### TECHNICAL FIELD

The present invention relates to a novel digital broadcasting viewing method. More specifically, the present invention relates to a novel digital broadcasting viewing method which enables a user to watch the programs to be viewed through a particular channel. The present invention also relates to a novel digital broadcasting viewing system.

### BACKGROUND ART

During TV watching, a user may browse channels using channel up/down keys to find the channel through which the preference program of the user is broadcasted. Differently from the analog broadcasting system, a variety of programs are provided to users through tens to hundreds channels in the digital broadcasting system. Accordingly, the channel browsing using the channel up/down keys takes a lot of time. The user may tune to the channel that he/she wants by directly inputting the channel number But, this is possible only when he/she knows the channel number through which the preference programs of the user is broadcasted.

Reservation is now utilized to improve the convenience of the user in watching television programs. In the existing reservation method, a user selects a preference program he/she wants and stores it in the memory. When the time at which the reserved program to start comes, tuning to the channel that broadcasts the preference program occurs automatically. But, this method does not satisfy the various needs of the user.

The most effective way to watch TV programs is that the user memorizes the time and the channel of each of the preference programs. Then, he/she may tune to particular channels at the right time through which the preference program is broadcasted. Suppose that the user wants to watch the program “STREET SIGHT” broadcasted at 5 o'clock through channel 1 and the program “MUSIC BOX”, broadcasted at 6 o'clock through channel 99. If the user memorizes these facts, he/she may tune to channel 1 at 5 o'clock to watch “STREET SIGHT” and then to channel 99 at 6 o'clock to watch “MUSIC BOX”. However, it is almost impossible for the users to memorize such information and it is not desirable to request them to do so.

### DISCLOSURE OF INVENTION

### Technical Problem

An object of the present invention is to provide a digital broadcasting viewing method which enables a user to reserve the programs he/she wants to watch into a particular virtual channel and to watch the reserved programs through the particular virtual channel.

Another object of the present invention is to provide an effective digital broadcasting viewing method which enables a user to select and bookmark the programs he/she wants to watch based on the program guide information into a particular virtual channel and to watch the booked programs by selecting the particular virtual channel.

### Technical Solution

According to a preferred embodiment of the present invention, there is provided a digital broadcasting viewing method comprising the steps of (a) assigning at least one channel that is not allocated to broadcast regular programs by broadcasting stations as my channel, (b) bookmarking a program that a user wants to watch into the my channel based on a program guide information, and (c) in response to selection of the my channel by the user, displaying the bookmarked program on television screen of the user.

According to another preferred embodiment of the present invention, there is provided a digital broadcasting viewing method, wherein two or more channels are assigned as my channel.

According to further another preferred embodiment of the present invention, there is provided a digital broadcasting viewing method, wherein the step (b) of bookmarking a program that a user wants to watch into my channel is carried out on an electronic program guide screen and a list of the bookmarked program is recorded into a my channel manager of a settop box.

According to still another preferred embodiment of the present invention, there is provided a digital broadcasting viewing method, in which the step (b) of bookmarking a program that a user wants to watch into my channel is carried out by cooperative operation of presetting of the list of the bookmarked program at a my channel managing server connected to the user's settop box through a data communication network and transmission of the list of the bookmarked program from the my channel managing server to the my channel manager of the user's settop box.

According to still further another preferred embodiment of the present invention, there is provided a digital broadcasting viewing method, in which the step (c) of displaying the bookmarked program on the television screen of the user is carried out by identifying the program and the channel in reference to the program information bookmarked into the my channel, and tuning to the channel.

According to still further another preferred embodiment of the present invention, there is provided a digital broadcasting viewing method, a system for embodying the digital broadcasting viewing method.

### Advantageous Effects

The digital broadcasting viewing method of the present invention using my channel provides the following advantageous effects.

First, thanks to my channel through which the preference programs of the users are always viewed, the user needs not browse channels to find out his/her preference programs, and thus, the time required for searching the preference program is reduced significantly.

Second, since the user can watch the programs bookmarked into the my channel by selection of the my channel at any time he/she wants, the interruption caused by automatic channel change in the conventional reservation system can be avoided.

Third, two or more channels can be assigned as my channels and channel change between my channels can be carried out by simply inputting the channel number. Accordingly, the user can watch his/her preference programs with minimized channel changing.

Fourth, my channel is a channel organized at the user's side, which makes the user feel more familiar with the television and encourages active participation of the user.

Fifth, the management of my channel by cooperative assistance by the external my channel managing server minimizes the time required for the editing of my channel by the user and solves the difficulty of text input at a television screen. Also, the external my channel managing server makes it easy to catch television watching pattern of the user in reference to the preference programs bookmarked in the my channel.

### BRIEF DESCRIPTION OF THE DRAWINGS

FIG. 1 is a program guide table illustrating an exemplarily embodiment of the bookmarking of the preference programs into my channel in accordance with the present invention.

FIG. 2 is a flow chart illustrating a preferred embodiment of the assignment of a particular channel as my channel in accordance with the present invention.

FIG. 3 is a flow chart illustrating a preferred embodiment of the bookmarking of the preference programs into my channel in accordance with the present invention.

FIG. 4 is a flow chart illustrating a preferred embodiment of the digital broadcasting viewing method in accordance with the present invention.

### MODE FOR THE INVENTION

The present inventors performed extended researches to find a method that enable a TV viewer to select preference programs simply and effectively. Based on the researches, it is confirmed that the purpose can be attained by use of “My Channel” (or “reservation channel”).

As used herein, “My Channel (or reservation channel)” refers to a virtual channel that is not allocated to broadcast regular programs by broadcasting stations, but into which preference programs is bookmarked or registered. Suppose that there are 99 channels serviced by a digital broadcasting. In this case, “channel 100” may be assigned as My Channel. Two or more channels can be assigned as My Channel. As thus, the number of My Channel is not limited to one but there may be two or more. The maximum number of My Channels is not restricted. Normally, it is expected that 1 to 10 channels may be assigned as My Channel. Preferably, 2 to 5 channels are allocated as My Channel. The My Channel enables a TV viewer to watch his/her preference programs by selection of a particular virtual channel.

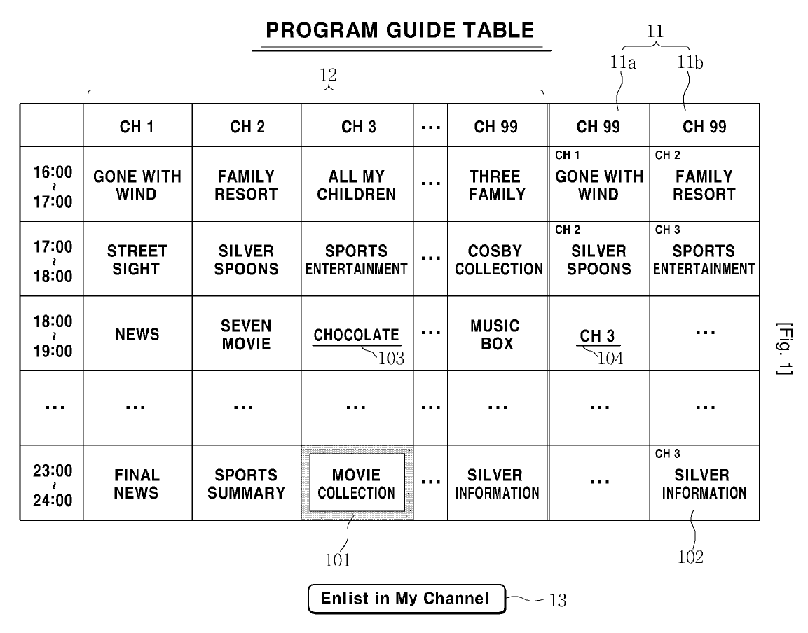

FIG. 1 is a program guide table illustrating an exemplarily embodiment of the bookmarking of the preference programs into my channel in accordance with the present invention. In the example, two channels, specifically the channel “100” (11a) and the channel “101” (11b) are assigned as My Channels (11). As shown in FIG. 1, the program guide table is classified into My Channel (11) and regular broadcasting channels (12). The regular broadcasting channels (12) offer programs provided by broadcasting stations. In the FIG. 1, channel Nos. 1 to 99 are exemplified as the regular broadcasting channels (12). My Channel (11) is a channel, preferably, created by the user by bookmarking the preference programs from those broadcasted on channel Nos. 1 to 99. In this example, the program “GONE WITH WIND” broadcasted on channel 1 is bookmarked into channel “100” (11a) at 16:00-17:00 and the program “FAMILY RESORT” broadcasted on channel 2 into “channel 101” (11b). Similarly, at 17:00-18:00, “SILVER SPOONS” broadcasted on channel 2 is bookmarked into “channel 100”(11a) and “SPORTS ENTERTAINMENT” broadcasted on channel 3 is bookmarked into “channel 101” (11b). Although not illustrated in the figure, various programs preferred by the user may be bookmarked into the My Channels (11) such as “channel 100” (11a) and “channel 101” (11b) in the same way. The number of My Channels (11) can be varied as long as the user can control them. Since the My Channels are virtual channels, they can be created in any numbers at the discretion of the user.

Suppose that a user who was watching TV on channel 5 wants to watch a bookmarked program. In accordance with the present invention, the user has only to input one of the channel numbers of My Channel (11). For example, the user may input the “channel number 100”(11a). In the conventional method, only one channel could be reserved for the same time. To the contrary, multiple programs can be reserved within the number of My Channels for the same time, in accordance with the present invention. As shown in FIG. 1, two programs can be reserved for the same time using “channel 100” (11a) and “channel 101” (11b). By selecting My Channel, the user can watch the bookmarked programs easily and conveniently. As mentioned in the above, the number of My Channels can be increased as the user wants. Thus, the number of programs to be bookmarked by the user can be increased, in proportion to the number of My Channels. Since My Channel (11) enlists the programs the user wants to watch, it always offers the programs the user wants. Consequently, the user can easily access his/her preference programs using My Channel (11) without the time-consuming search for the right channels. Suppose that a user prefers sport, movie and drama. The user may enlist various sports programs he/she wants to watch in “channel 100” (11a), preference movies in “channel 101” (11b) and preference dramas in “channel 102” (not shown). Then, the user can easily access his/her preference programs only by changing channels from 100 to 102. And, since the channel changing is carried out by the user's My Channel selection, the user's TV watching is not interrupted by automatic channel change to the reserved program, compared with the convention booking method. These are ones of the distinguishing points of the digital broadcasting viewing method of the present invention.

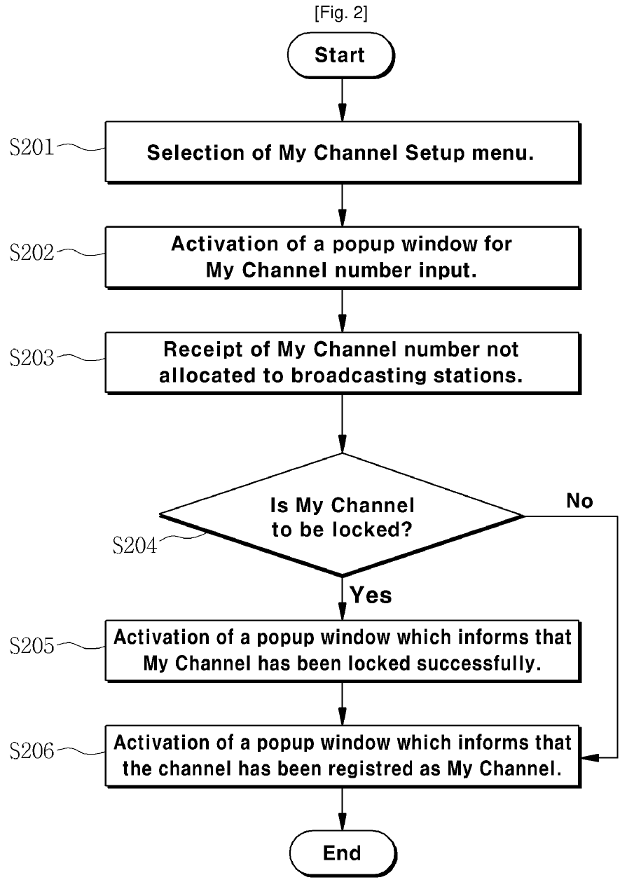

FIG. 2 is a flow chart illustrating a preferred embodiment of the assignment of a particular channel as my channel in accordance with the present invention. Among various menus, “My Channel Setup” menu is selected using a remote controller (S201). When the “My Channel Setup” menu is selected, a popup window is activated in which a channel to be assigned as My Channel is input (S202). A virtual channel not allocated to broadcast regular programs by broadcasting stations is input in the popup window (S203). If necessary, the My Channel can be locked. In this case, it is determined if My Channel is to be locked (S204). If so, a popup window is activated which informs that My Channel has been locked successfully (S205). Then, a popup window is activated which informs that the corresponding channel has been successfully allocated as My Channel (S206). Two or more channels may be registered as My Channel in the same way.

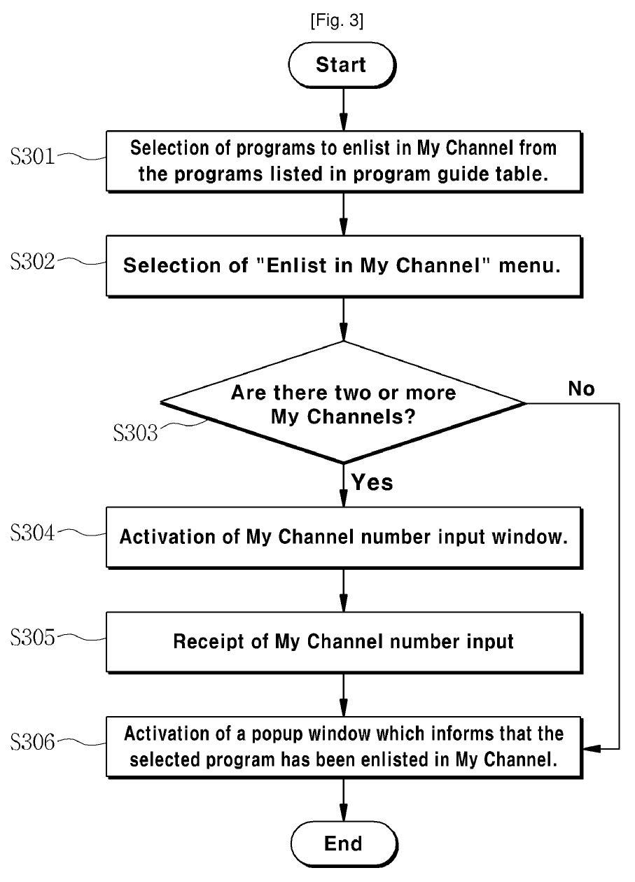

FIG. 3 is a flow chart illustrating a preferred embodiment of the bookmarking of the preference programs into my channel in accordance with the present invention. The procedure of registering preference programs into My Channel is explained referring to FIG. 1 and FIG. 3. First, of the programs listed in the program guide table shown in FIG. 1, the programs to be registered into My Channel (11) are selected (S301). In FIG. 1, the highlighted program (101) is to be registered into My Channel. Then, the “Enlist in My Channel” menu (13) is selected from the program guide table (S302). In case two or more channels are registered as My Channel (S303), a My Channel number input window is activated (S304) to prompt the input of the My Channel number by the user. When the My Channel number is input successfully (S305), a popup window is displayed on the user's screen which informs that the selected program has been successfully registered (S306). In this way, the program the user wants to watch is bookmarked into My Channel. Suppose that the highlighted program (101) is to be registered in “channel 101” (11b). In this case, “Enlist in My Channel” menu (13) is selected while the program remains highlighted. Then, the number “101” is input in the My Channel number window. If the input is competed, a popup window is activated which informs that the program has been bookmarked successfully and the program information (e.g., channel number and program title) of the highlighted program is recorded in “channel 101”0 (11b) for the corresponding time (102).

Bookmarking of the preference programs into My Channel can be performed in a variety of ways. For example, it can be performed by direct input of the channel number into My Channel list. Suppose that the program “CHOCOLATE” (103) broadcasted on channel 3 at 18:00-19:00 is to be bookmarked into “channel 100” (11a). In that case, the channel number “3” can be directly input in the input space (104) of the program guide table (1), corresponding to the particular channel (11a) and time, to register the program into My Channel.

If necessary, registering of a program into My Channel can be performed using an external my channel managing server connected to the settop box through a data communication network. A user hooks up to the external my channel managing server using a computer and bookmarks the programs he/she wants to watch using the Enlist in My Channel menu provided by the server in the manner described above, which is stored in the my channel managing server. Then, the data of my channel registry can be requested to be downloaded to the user's settop box.

The selection of My Channel can be performed by any common method. For example, My Channel can be selected: by directly inputting the channel number corresponding to the My Channel, by manipulating channel up/down keys to move to My Channel; by selecting My Channel from an electronic program guide screen; or by selecting My Channel from a portal menu bar.

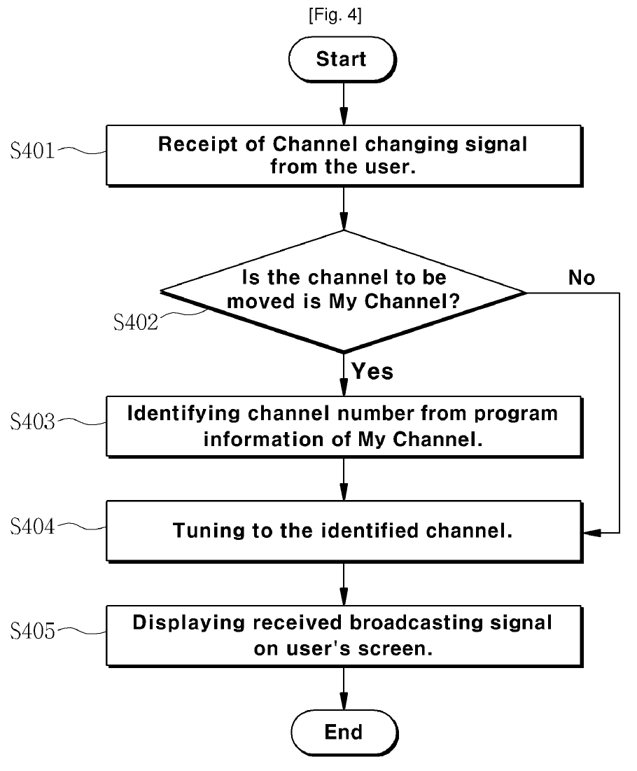

FIG. 4 is a flow chart illustrating a preferred embodiment of the digital broadcasting viewing method in accordance with the present invention. When a channel changing signal is received from the user (S401), it is determined if the channel to be moved to is My Channel (S402). If the channel to be moved is My Channel, the channel number is identified from the program information of the My Channel, referring to the My Channel management table stored, for example, into the memory (S403). Then, a control signal is generated which commands to move to the identified channel, and in response to the control signal, tuning to the channel occurs (S404). If the channel input by the user is a regular broadcasting channel, not My Channel, tuning to the corresponding channel occurs right now as in the conventional process (S404). The broadcasting signal of the tuned channel is processed by a broadcasting signal processing means and is displayed on the user's screen (S405).

The present invention also provides a digital broadcasting program viewing system, which comprises a means for receiving a user's channel changing signal, a means for receiving a user's channel changing signal, a means for storing a My Channel management table into which program information bookmarked into My Channel is recorded, a means for determining if a channel to be moved by the user's channel changing signal is My Channel and, if the channel to be moved is the My Channel, checking the program information from the my channel management table to identify the channel bookmarked into the corresponding my channel, a means for generating a control signal which commands to move to the identified channel, a means for tuning to the channel corresponding to the control signal, a means for processing a broadcasting signal from the tuned channel, and a means for displaying the broadcasting signal on a user's screen. Typically, the My Channel management table is stored in a non-volatile memory.

As described, it should be evident that the present invention can be implemented through a variety of configurations in the aforementioned technical field, without affecting, influencing or changing the spirit and scope of the present invention. Therefore, it is to be understood that the examples and applications illustrated herein are intended to be in the nature of description rather than of limitation. Furthermore, the meaning, scope and higher conceptual understandings of the present patent application as well as modifications and variations that arise therefrom should be understood to be extensions to this application.

1. A digital broadcasting viewing method comprising the steps of:
(a) assigning at least one channel that is not allocated to broadcast regular programs by broadcasting stations as my channel;
(b) bookmarking a program that a user wants to watch into the my channel based on a program guide information; and
(c) in response to selection of the my channel by the user, displaying the program bookmarked into the my channel on television screen of the user.

2. The digital broadcasting viewing method as set forth in claim 1, wherein two or more channels are assigned as the my channel.

3. The digital broadcasting viewing method as set forth in claim 2, wherein the channels assigned as the may channel is in a range of 2 to 5.

4. The digital broadcasting viewing method as set forth in claim 2, wherein the channels assigned as my channel are managed in terms of themes.

5. The digital broadcasting viewing method as set forth in claim 1, wherein the step (b) of bookmarking a program that a user wants to watch into my channel is carried out on an electronic program guide screen and the bookmarked program is recorded into a my channel management table of a settop box.

6. The digital broadcasting viewing method as set forth in claim 1, wherein the step (b) of bookmarking a program that a user wants to watch to my channel is carried out by cooperative operation of presetting of the bookmarking of the program at a my channel managing server connected to the user's settop box through a data communication network and transmission of the information on the bookmarked program from the my channel managing server to a settop box of the user.

7. The digital broadcasting viewing method as set forth in claim 1, wherein the step (c) of displaying the program bookmarked into the my channel on the television screen of the user is carried out by identifying the channel through which the program bookmarked into the my channel is broadcasted and tuning to the identified channel.

8. A digital broadcasting program viewing system, which comprises:
a means for receiving a user's channel changing signal;
a means for storing a my channel management table into which program information bookmarked into my channel is recorded;
a means for determining if a channel to be moved by the user's channel changing signal is my channel and, if the channel to be moved is the my channel, checking the program information from the my channel management table to identify the channel bookmarked into the corresponding my channel;
a means for generating a control signal which commands to move to the identified channel;
a means for tuning to the channel corresponding to the control signal;
a means for processing a broadcasting signal from the tuned channel; and
a means for displaying the broadcasting signal on a user's screen.
